(19) United States
(12) Patent Application Publication
(10) Pub. No.: US 2023/0132723 A1
(43) Pub. Date: May 4, 2023

(54) VAPING DEVICE

(71) Applicant: Tuanfang LIU, Shenzhen (CN)

(72) Inventor: Tuanfang LIU, Shenzhen (CN)

(21) Appl. No.: 17/699,151

(22) Filed: Mar. 20, 2022

(30) Foreign Application Priority Data
Nov. 1, 2021 (CN) 202111282512.8
Nov. 1, 2021 (CN) 202122647445.7

(51) Int. Cl. A24F 40/46; A24F 40/20; A24F 40/485; A24F 40/42; A24F 40/57; A24F 40/51; H05B 3/42

(52) U.S. Cl. CPC A24F 40/46; A24F 40/20; A24F 40/485; A24F 40/42; A24F 40/57; A24F 40/51; H05B 3/42

(57) ABSTRACT

A vaping device includes a heating assembly; the heating assembly includes a first chamber and a heating element disposed in the first chamber. The first chamber includes a first air intake part and an air release part. The tobacco material is disposed outside of the first chamber, and the air release part is disposed toward the tobacco material.

### CROSS-REFERENCE TO RELATED APPLICATIONS

Pursuant to 35 U.S.C.§ 119 and the Paris Convention Treaty, this application claims foreign priority to Chinese Patent Application No. 202111282512.8 filed Nov. 1, 2021, and to Chinese Patent Application No. 202122647445.7 filed Nov. 1, 2021. the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a vaping device.

A conventional vaping device includes a heating element in direct contact with the tobacco material, so that the tobacco material is heated unevenly, thus affecting the taste of tobacco smoke.

### SUMMARY

The disclosure provides a vaping device.

The following advantages are associated with the vaping device of the disclosure: the vaping device comprises a first chamber for concentrating the heat produced by a heating element; and external air transfers the heat throughout the tobacco material, thus improving the taste of tobacco smoke.

### BRIEF DESCRIPTION OF THE DRAWINGS

FIG. 1 is an exploded view of a vaping device according to one example of the disclosure;

FIG. 2 is a perspective view of a vaping device according to one example of the disclosure;

FIG. 3 is a cross-sectional view of a vaping device according to one example of the disclosure;

FIG. 4 is an exploded view of a heating assembly according to one example of the disclosure;

FIG. 5 is a perspective view of a heating assembly according to one example of the disclosure;

FIG. 6 is a bottom perspective view of a holder according to one example of the disclosure;

FIG. 7 is a cross-sectional view of a heating assembly according to one example of the disclosure; and

FIG. 8 is a cross-sectional view including arrows showing the direction of the airflow in a vaping device according to one embodiment of the disclosure.

In the drawings, the following reference numbers are used: 1. Mirror; 2. Light guide ring; 3. Screw; 4. Shell; 5. Power button; 6. Second cover 7. Circuit board; 8. Negative plate; 9. Support frame; 10. Thermally-insulating ring; 11. Temperature sensor; 12. Temperature monitoring tube; 13. Sleeve; 14. Second electrode connector; 15. First insulator; 16. First electrode connector; 17. fist cover; 18. Second screw; 19. Second electrode; 20. First electrode; 21. Second insulator; 22. Second fixing part; 23. First fixing part; 24. First headwall; 25. Heating element; 26. Holder; 27. Thermally-insulating gasket; 28. Base; 29. Tobacco chamber; 100. Heating assembly; 200. Control assembly; 300. Heat dissipation space; 401. Fourth cavity; 901. Fifth through hole; 1401. Third channel; 1601. Fin; 1602. First channel; 1701. Second through hole; 1702. Third cavity; 1703. Second chamber; 1704. Air channel; 1705. Third headwall; 1706. Second sidewall; 2001. Second channel; 2301. Fourth through hole; 2401. Air inlet; 260. Partition; 2601. Separate part; 2602. Hole; 2603. First sidewall; 2604. Air outlet; 2605. First chamber; 2606. Opening; 2607. Main partition; 2607a; First main partition; 2607b. Second main partition; 2607c. Third main partition; 2608. Auxiliary partition; 2608a. First auxiliary partition; 2608b. Second auxiliary partition; 2608c. Third main partition; 2609. Second headwall; 2610. Flange; 2801. Third sidewall; 2802. First through hole; 2809. Fourth headwall; 2901. First cavity; and 2902. Exhaust pipe.

### DETAILED DESCRIPTION

To further illustrate the disclosure, embodiments detailing a vaping device are described below. It should be noted that the following embodiments are intended to describe and not to limit the disclosure.

The term “tobacco material”, as used herein, refers to those substances which can be heated, burned, or atomized to produce smoke that typically contains nicotine, and/or flavoring. The tobacco material is liquid, solid, or semisolid. The solid tobacco material is typically cut into thin slices or strips. The tobacco material may be a natural or processed tobacco, such as tobacco tar, tobacco paste, tobacco leaf, or other materials. The processed tobacco contains mainly glycerin, propylene glycol, and nicotine. The tobacco material may be enclosed in an outer shell. The outer shell, such as microcapsules, is broken down at high temperatures and thus volatile substances are released.

The tobacco material is classified into nicotine-containing tobacco or nicotine-free tobacco. The nicotine-free tobacco contains mainly aroma substances, such as fragrance agents, which can be atomized to simulate aspects of cigarette smoking, thus increasing smoker's odds of quitting smoking. In certain examples, the fragrance agents comprise peppermint oil. Optionally, the tobacco materials further comprise other additives, such as glycerin and/or propylene glycol.

The term “heating assembly”, as used herein, refers to a device that converts electrical energy into thermal energy for heating the tobacco material.

The term “heating element”, as used herein, refers to a component that generates heat by converting electrical energy into thermal energy or by inducing electrical currents in response to a changing magnetic field. In other words, the heating element is energized to produce heat or is disposed in a magnetic field in a coil to transfer heat energy to the tobacco material.

In certain examples, as shown in FIG. 7, the vaping device comprises a heating assembly 100; the heating assembly 100 comprises a first chamber 2605 and a heating element 25 disposed in the first chamber 2605; the first chamber 2605 comprises a first air intake part and an air release part; the tobacco material is disposed outside of the first chamber 2605, and the air release part is disposed toward the tobacco material. Understandably, the first air intake part and air release part are holes or channels through which the air or smoke can flow away; the tobacco material is disposed outside of the first chamber 2605 without any contact with the heating element 25; external air flows through the first air intake part into the first chamber 2605, forcing the air heated by the heating element 25 from the first chamber 2605 through the air release part to the tobacco material, thus improving the taste of tobacco smoke.

The heating element 25 comprises a conductive material including, not limited to, a conductive metal, graphene, and carbon nanomaterials.

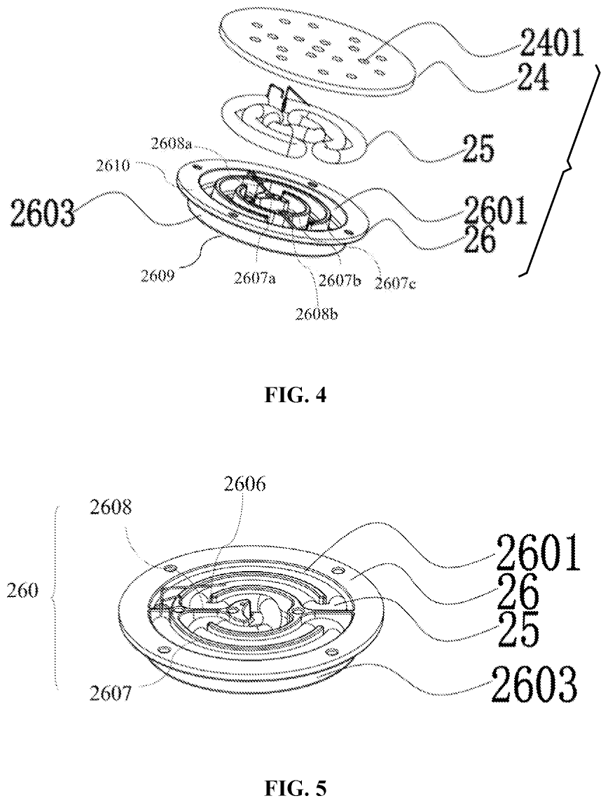

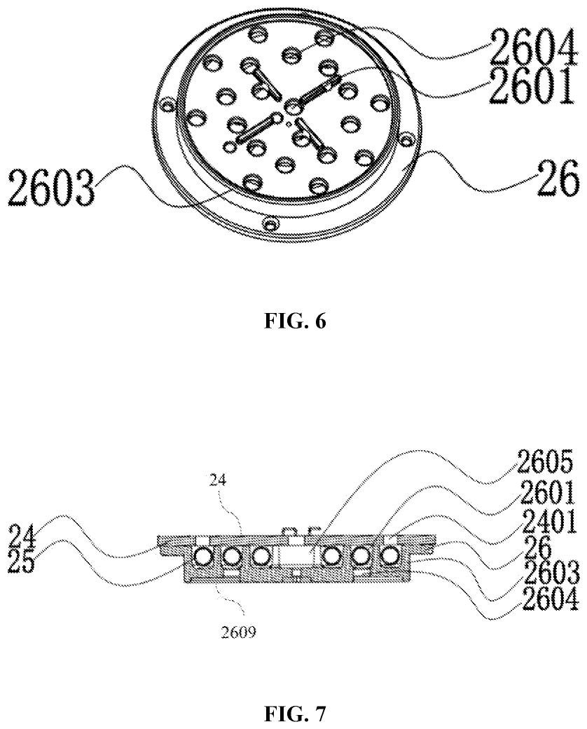

In certain examples, as shown in FIGS. 4-7, the heating assembly 100 comprises a first headwall 24, a second headwall 2609, and a first sidewall 2603; the first headwall 24 and the second headwall 2609 are disposed on both ends of the first sidewall 2603; the first chamber 2605 is surrounded by the first headwall 24, the second headwall 2609, and the first sidewall 2603; the first air intake part is disposed on the first headwall 24, and the air release part is disposed on the second headwall 2609. In certain examples, the second headwall 2609 is formed integrally with the first sidewall 2603 to form a holder 26; the second headwall 2609 and the first sidewall 2603 comprise thermally-conductive and electrically insulating materials, such as ceramics, glass, and quartz, which can increase the heating area. In certain examples, the first headwall 24 comprises a thermally insulating material by which the heat is retained in the first chamber 2605 and transferred to the tobacco materials through the second headwall 2609 and the air release part; the thermally insulating material includes, but is not limited to, mica, agate, jade, and crystal, and preferably mica. The first headwall 24 may be formed integrally with, fixedly or detachably connected to the first sidewall 2603.

In certain examples, the first sidewall 2603 comprises a distal end away from the second headwall 2609; the distal end extends radially outward to form a flange 2610; and the first headwall 24 is fixedly disposed on the flange 2610.

In certain examples, the first air intake part comprises a plurality of air inlets 2401, and the air release part comprises a plurality of air outlets; the plurality of air inlets 2401 communicates with the plurality of air outlets through the first chamber 2605; the projections of the plurality of air inlets 2401 onto the second headwall 2609 do not overlap with the plurality of air outlets. In this way, the hot air flow forms a vortex in the first chamber 2605, which increases the moving distance of the hot air, thus reducing heat loss and improving heat utilization.

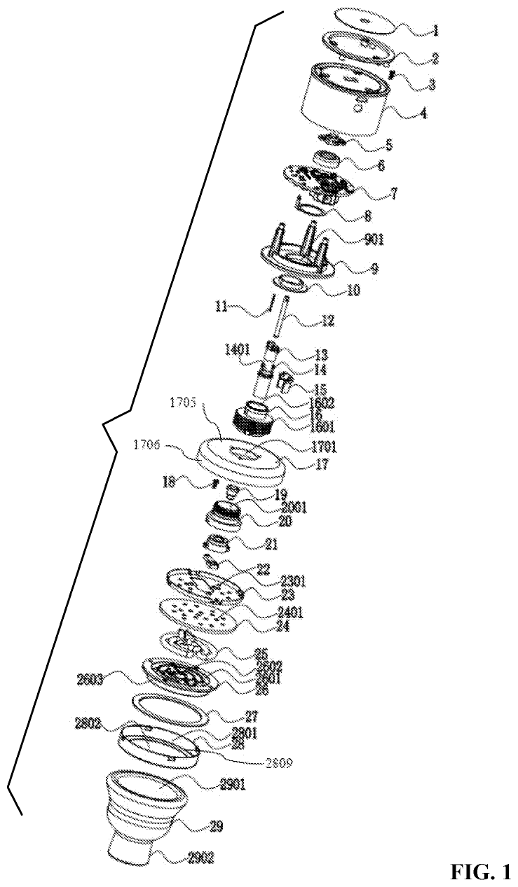

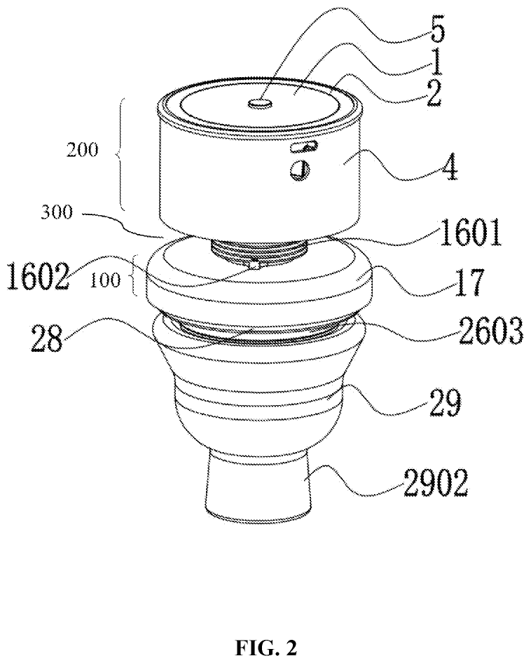

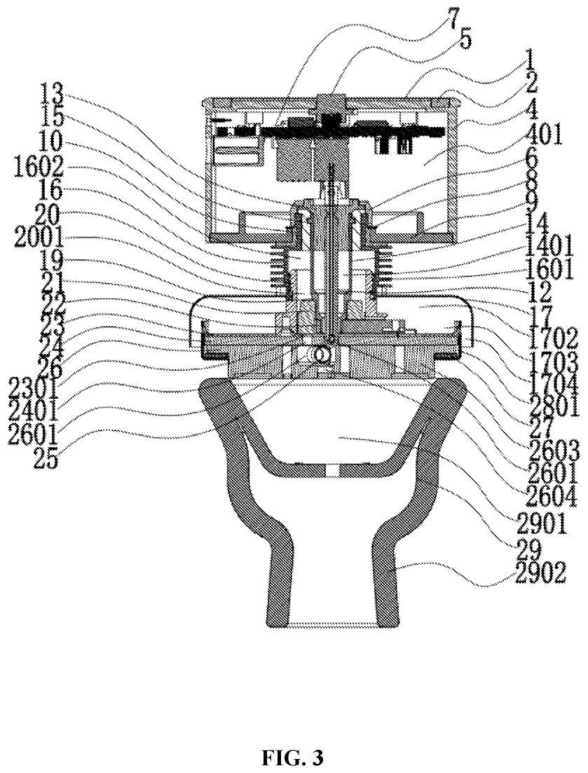

In certain examples, as shown in FIGS. 1-3, the vaping device further comprises a tobacco chamber 29 comprising an open top (not shown); the tobacco chamber 29 comprises a first cavity 2901 for holding the tobacco material; the second headwall 2609 is disposed on the open top to cover the first cavity 2901; and the air release part (i.e. the plurality of air outlets 2604) is disposed toward the tobacco material to concentrate the heat, thus reducing heat loss and speeding up the process of heating the tobacco material.

In certain examples, the vaping device further comprises a control assembly 200; a heat dissipation space 300 is formed between the control assembly 200 and the heating assembly 100 so as to prevent the heat of the heating assembly 100 from being transferred to the control assembly 200, thus extending service life of the control assembly 200.

In certain examples, the heating assembly 100 further comprises a distal end away from the tobacco material; the control assembly 200 is disposed on the distal end to keep a safe distance from the heating assembly 200 and extend its service life.

In certain examples, the vaping device further comprises a plurality of fins 1601 disposed in the heat dissipation space 300; the plurality of fins 1601 comprises a conductive metal, including but not limited to, an aluminum sheet, and a copper sheet. The plurality of fins is configured to increase heat dissipation and thus prevents the control assembly 200 from overheating.

In certain examples, the control assembly 200 further comprises a shell 4 and a circuit board 7; and the shell 4 comprises a second cavity 401 in which the circuit board 7 is fixedly disposed. The shell 4 is configured to prevent the circuit board 7 from being damaged.

In certain examples, the vaping device further comprises a first electrode connector 16 and a second electrode connector 14; the heating element 25 is electrically connected to the circuit control board 7 through the first electrode connector 16 and the second electrode connector 14; the heat dissipation space 300 is formed outside the shell 4; the first electrode connector 16 and the second electrode connector 14 are, at least partially, disposed in the heat dissipation space 300; the plurality of fins is disposed on the first electrode connector 16 and/or the second electrode connector 14. Understandably, the first electrode connector 16 and the second electrode connector 14 are made of conductive materials, including but not limited to, copper, silver, and aluminum; the first electrode connector 16 and the second electrode connector 14 are configured to conduct electricity, secure the control assembly 200 to the heating assembly 100, and separate the control assembly 200 and the heating assembly 100.

In certain examples, the heating assembly 100 further comprises a first electrode 20 and a second electrode 19. The heating element 25 is electrically connected to the first electrode 20 and the second electrode 19. The first electrode 20 and the second electrode 19 are electrically connected to the first electrode connector 16 and the second electrode connector 14, respectively. Understandably, the first electrode connector 16, the second electrode connector 14, the first electrode 20, and the second electrode 19 make the vaping device easy to assemble. The first electrode 20 and the second electrode 19 are made of conductive metals, including but not limited to, copper, silver, and aluminum.

In certain examples, the shell 4 comprises a through hole (not shown). One end of the first electrode connector 16 is disposed through the through hole into the second cavity 401 to electrically connect to the circuit board 7; another end of the first electrode connector 16 is disposed through the through hole and exposed outside the shell 4, to electrically connect to the first electrode 20. Understandably, the first electrode connector 16 is fixedly electrically connected to the first electrode 20 using any suitable connection mean, such as threaded screws, fasteners, and interference fits.

In certain examples, the first electrode connector 16 comprises a first channel 1602 in which the second electrode connector 14 is disposed; the vaping device further comprises a first insulator 15 disposed between the second electrode connector 14 and the first electrode connector 16; one end of the second electrode connector 14 is electrically connected to the circuit board 7; another end of the second electrode connector 14 is electrically connected to the second electrode 19. Understandably, the second electrode connector 14 is electrically connected to the second electrode 19 using any desired connection means, such as threaded screws, fasteners, and interference fits. The first insulator 15 is made of silica gel, plastic, etc. The first insulator 15 is in the shape of a sleeve or a half-round sleeve. The first insulator 15 is disposed in the first channel 1602 to sleeve the second electrode connector 14, thus insulating electricity and preventing changes in the position of the second electrode connector 14.

In certain examples, the first electrode 20 comprises a second channel 2001 in which the second electrode 19 is disposed. The vaping device further comprises a second insulator 21 disposed between the second electrode 19 and the first electrode 20. The second insulator 21 is made of silica gel, plastic, etc. The second insulator 21 is in the shape of a sleeve or a half-round sleeve. The second insulator 21 is disposed in the second channel 2001 to sleeve the second electrode 19, thus insulating electricity and preventing changes in the position of the second electrode 19.

In certain examples, the plurality of fins 1601 extends radially outward from the outer wall of the first electrode connector 16; the plurality of fins 1601 is made of a conductive metal which may be the same as that of the first electrode connector 16; the conductive metal is electrically and thermally conductive, includes, but is not limited to, copper, aluminum, and silver. Understandably, the plurality of fins 1601 is disposed at intervals in an axial direction along the outer wall of the first electrode connector 16; when the vaping device is energized, the heat is produced and transferred from the first electrode connector 16 to the plurality of fins 1601 for increased heat dissipation.

In certain examples, the vaping device further comprises a first cover 17 disposed outside the first headwall 24; a second chamber 1703 is formed between the first cover 17 and the first headwall 24; the vaping device further comprises a second air intake part disposed in the second chamber 1703. Understandably, the first cover 17 is disposed above the heating assembly 100; the heat dissipation space 300 and the plurality of fins 1601 are disposed between the first cover 17 and the shell 4; the first electrode connector 16 is configured to separate the shell 4 and the first cover 7; the first cover 7 is configured for thermal insulation; the second chamber 1703 is configured to concentrate the heat, reduces heat loss, and allows the maximum airflow to flow through the heating assembly; and the second air intake part comprises at least one hole or channel.

In certain examples, the heating assembly 100 further comprises a base 28; the first cover 17 is disposed on the base 28; the first cover 17 comprises a third headwall 1705 and a second sidewall 1706; the third headwall 1705 is disposed on one end of the second sidewall 1706; a third cavity 1702 is surrounded by the third headwall 1705 and the second sidewall 1706; the first headwall 24 is disposed opposite to the third headwall 1705; the base 28 comprises a fourth headwall 2809 and a third sidewall 2801; the fourth headwall 2809 is disposed on one end of the third sidewall 2801; the second sidewall 1706 is disposed around the third sidewall 2801, and an air channel 1704 is formed between the second sidewall 1706 and the third sidewall 2801. The air channel 1704 functions as the second air intake part. Understandably, the third headwall 1705 is connected to the top part of the second sidewall 1706; the fourth headwall 2809 is connected to the bottom part of the third sidewall 2801; the air flows only through the air channel 1704 into the second chamber 1703 and is then heated by the heating assembly 100; so, the heated air flows up more readily to prevent the heat from escaping through the air channel 1704; the third headwall 1705 is formed integrally with the second sidewall 1706; and the fourth headwall 2809 is formed integrally with the third sidewall 2801.

In certain examples, the fourth headwall 2809 comprises a first through hole 2802, and the distal end of the first sidewall 2603 extends radially outward to form a flange 2610; the first sidewall 2603 and the second headwall 2609 are disposed through the first through hole 2802, and the flange 2610 is disposed on the fourth headwall 2809. Understandably, the first sidewall 2603, the second headwall 2609, and the flange 2610 are formed integrally and comprise a conductive material; the conductive material allows heat energy to be rapidly transferred from the heating element 25 to the first sidewall 2603 and the second headwall 2609; the first sidewall 2603 and the second headwall 2609 are disposed through the first through hole 2802 into the tobacco chamber 29 to concentrate the heat energy onto the tobacco material, thus speeding up the heating process; the base 28 is fitted together with the first cover 17 to form the air channel 1704, and prevents the heat from escaping from the heating assembly 100; the third sidewall 2801 is extended upward with respect to the first headwall 24 so as to increase the length of the air channel 1704, thus reducing heat loss.

In certain examples, the vaping device further comprises a thermally-insulating gasket 27 disposed between the fourth headwall 2809 and the flange 2610.

In certain examples, the third headwall 1705 comprises a second through hole 1701; the heating assembly 100 is disposed through the second through hole 1701 so as to be energized by a power supply; the first electrode 20 is disposed in the second chamber 1703; the second electrode 19 is disposed in the second channel 2001; and the first electrode 20 is disposed through the second through hole 1701 so as to electrically connect to the first electrode connector 16.

In certain examples, as shown in FIGS. 4-6, the heating element 25 is disposed in the first chamber 2605; when energized, the heating element 25 converts electrical energy into heat energy; a plurality of partitions is disposed on the second headwall 2609 so as to separate the first chamber into a plurality of separate parts 2601. Understandably, the heating element 25 is disposed in the plurality of separate parts 2601; the plurality of partitions 260 is erected on the second headwall 2609; the plurality of partitions 260 is formed integrally with or fixed on the second headwall 2609; the plurality of separate parts 2601 is configured to prevent changes in the position of the heating element 25, which avoids short circuit of the heating element 25, thus reducing heat loss and concentrating the heat energy in the plurality of separate parts 2601.

In certain examples, the plurality of separate spaces 2601 communicates with one another to form a passage; two ends of the heating element 25 extend in the passage so that the heating element stretches in each separate space; the vaping device comprises only one heating element 25, comprising two pins for electricity conducting; the only one heating element 25 is electrically connected to the two pins using welded connection by which the production efficiency is improved in simple steps; and the length of the heating element 25 causes a rise in voltage and maximizes the amount of the heat produced. In certain examples, the plurality of separate parts 2601 need not communicates with one another; the heating assembly comprises a plurality of heating elements 25 disposed through the plurality of partitions 260; and the plurality of heating elements 25 is formed integrally with or connected to one another.

In certain examples, the plurality of partitions 260 comprises a plurality of main partitions 2607 with different sizes; each of the plurality of main partitions 2607 is in the shape of a ring with an opening 2606; a separate part 2601 is formed between every two adjacent main partitions 2607; a smaller main partition 2607 is disposed in an adjacent larger main partition, and the opening of the smaller main partition and the opening of the adjacent larger main partition are disposed in two opposite directions. Understandably, the plurality of main partitions 2607 can be any shape or form including a circular shape, an elliptical shape, and a polygonal shape (for example, a rectangular shape, a triangular shape, and a diamond shape). In certain examples, the plurality of main partitions 2607 comprises a first main partition 2607a, a second main partition 2607b, and a third main partition 2607c, which are disposed in that order outward from center. The first main partition 2607a comprises a first opening; the second main partition 2607b comprises a second opening; and the third main partition 2607c comprises a third opening; the first main partition 2607 is surrounded by the second main partition 2607b, and the first opening and the second opening are disposed in two opposite directions; the second main partition 2607b is surrounded by the third main partition 2607c, and the second opening and the third opening are disposed in two opposite directions; the first opening and the third opening are disposed in the same direction. In certain examples, each of the plurality of main partitions 2607 is in the form of a sheet (as shown in FIG. 7), and need not comprises any opening 2606. In certain examples, the plurality of main partitions 2607 is spirally disposed on the second headwall 2609 and need not comprise any opening 2606; and the heating element 25 is matched with the plurality of separate parts 2601 in shape so that it can be disposed therein.

In certain examples, each of the plurality of partitions 260 further comprises a joint and an auxiliary partition 2608; the joint is disposed opposite to the opening; and the auxiliary partition extends from the joint through the opening of adjacent larger main partition. In certain examples, the plurality of main partitions 2607 comprises a first main partition 2607a, a second main partition 2607b, and a third main partition 2607c, which are disposed in that order outward from the center; the first main partition 2607a comprises a first opening and a first joint disposed opposite to the first opening; the second main partition 2607b comprises a second opening and a second joint disposed opposite to the second opening; and the third main partition 2607c comprises a third opening and a third joint disposed opposite to the third opening; the first main partition 2607 is surrounded by the second main partition 2607b, and the first opening and the second opening are disposed in two opposite directions; the second main partition 2607b is surrounded by the third main partition 2607c, and the second opening and the third opening are disposed in two opposite directions; the first auxiliary partition 2608a extends from the first joint to the third joint through the second opening; the second auxiliary partition 2608b extends from the second joint to the first sidewall 2603 through the second opening. The plurality of auxiliary partitions 2608 is configured to prevent short circuit caused by the heating element 25.

In certain examples, the heating element 25 comprises a heating wire and/or a heating tube in a spiral shape that gives the maximum heating area. Preferably, the heating wire is in the shape of a spiral that gives the maximum length, offering advantages such as low electrical resistivity, high heat generation, and low power consumption; and the heat is transferred rapidly to the tobacco material to improve the taste of the tobacco smoke.

In certain examples, the heating assembly further comprises a temperature sensor 11 disposed in the first chamber 2605 and electrically connected to the circuit board 7. Since toxic substances may be produced on heating the tobacco material at high temperature, the temperature sensor 11 is configured to regulate the operation of the heating element 25, thus controlling the temperature of the first chamber 2605 and/or the second headwall 2609 and/or the first sidewall 2603. The temperature sensor 11 is further configured to prevent the heating element 25 from overheating.

In certain examples, the temperature sensor 11 is disposed in or close to a middle position of the first chamber 2605 to measure air temperature accurately.

In certain examples, the heating assembly further comprises a temperature monitoring tube 12; and the second electrode connector 14 comprises a third channel 1401 in which the temperature monitoring tube 12 is disposed; the second electrode 19 comprises a third through hole (not shown); the temperature monitoring tube 12 is inserted into the first chamber 2605 through the third channel 1401 and the third through hole; and the first chamber 2605 comprises a hole 2602 into which one end of the temperature monitoring tube 12 is fixedly disposed.

In an alternative preferred examples of the disclosure, as shown in FIGS. 1-7, the vaping device comprises a mirror 1, a light guide ring 2, a first screw 3, a shell 4, a power button 5, a second cover 6, a circuit board 7, a negative plate 8, a support frame 9, a thermally-insulating ring 10, a temperature sensor 11, a temperature monitoring tube 12, a sleeve 13, a second electrode connector 14, a first insulator 15, a first electrode connector 16, a first cover 17, a second screw 18, a second electrode 19, a first electrode 20, a second insulator 21, a second fixing part 22; a first fixing part 23, a first headwall 24, a heating element 25, a holder 26, a thermally-insulating gasket 27, a base 28, and a tobacco chamber 29.

The holder 26 comprises a first sidewall 2603 and a second headwall 2609. The second headwall is secured to one end of the first sidewall 2603 using integral formation. The top end of the first sidewall 2603 extends radially outward to form a flange 2610. The first headwall 24 is fixedly disposed on the flange 2610 or the top end of the first sidewall 2603 by a fastener (e.g. a screw). The second headwall 2609 comprises a plurality of air outlets 2604 through which the air and heat can flow away.

The holder further comprises a plurality of main partitions 2607 disposed in order outward from center. Each of the plurality of main partitions 2607 is in the shape of a ring with an opening 2606. A separate part 2601 is formed between every two adjacent main partitions 2607. A smaller main partition 2607 is disposed in an adjacent larger main partition, and the openings of the smaller main partition 2607 and the adjacent larger main partition 2607 are disposed in two opposite directions. Each of the plurality of partitions 260 further comprises a joint and an auxiliary partition 2608. The joint is disposed opposite to the opening; and the auxiliary partition extends from the joint through the opening of adjacent larger main partition. The heating element 25 is fixedly disposed in the separate part 2601 to convert electrical energy into heat energy. Each of the plurality of air outlets 2604 is disposed on the corresponding separate part 2601 and it communicates with one another through the separate part 2601.

The base 28 comprises a fourth headwall 2809 and a third sidewall 2801. The fourth headwall 2809 is disposed on one end of the third sidewall 2801. The fourth headwall 2809 comprises a first through hole 2802 through which the first sidewall 2603 and the second headwall 2609 are inserted, and the flange 2610 is disposed on the fourth sidewall 2809. The thermally-insulating gasket 27 is disposed between the fourth headwall 2809 and the flange 2610 to prevent heat transfer.

The first headwall 24 is disposed on the top part of the holder 26 to prevent the heat from escaping the separate part 2601. The first fixing part 23 is fixedly disposed on the first headwall 24 and the base 28 so as to fix the first headwall 24. The first headwall 24 comprises a plurality of air inlets 2401 communicating with the plurality of air outlets 2604, respectively. The first fixing part 23 comprises a plurality of fourth through holes 2301 corresponding with the plurality of air inlets 2401, respectively. The plurality of air inlets 2401, the plurality of air outlets 2604, and the plurality of fourth through holes 2301 are configured to allow the air and smoke to flow through. The plurality of air inlets 2401 is projected vertically on the second headwall 2609 to ensure that the projection and the plurality of air outlets 2604 do not overlap.

The shell 4 comprises a fourth cavity 401 in which the circuit board 7 is fixedly disposed to regulate the operation of the heating element 25. The power button 5 is disposed on the circuit board 7, and the top part of the power button is exposed outside the top part of the shell 4. The light guide ring 2 is fixedly disposed on the top part of the shell 4 by a first screw 3 so as to display information about working state. The mirror 1 is attached to the top part of the shell 4 to give an improved visual aesthetic. The support frame 9 is disposed on the bottom part of the casing 4 to fix the circuit board 7 in the fourth cavity 401. The support frame 9 comprises a fifth through hole 901 in which the thermally-insulating ring 10 is fixedly disposed. The top part of the first electrode connector 16 is disposed through the thermally-insulating ring 10 into the fourth cavity 401. The negative plate 8 is disposed on the top part of the first electrode connector 16 to conduct electricity. The second cover 6 is disposed on the top part of the first electrode connector 16 so as to fix the negative plate 8 on the first electrode connector 16. The circuit board 7 comprises an output terminal, comprising a positive electrode and a negative electrode. The negative electrode of the circuit board 7 is soldered to the negative plate 8 to conduct electricity. The first electrode connector 16 is disposed outside of the fourth cavity 401. The outer wall of the first electrode connector 16 comprises a plurality of fins which is formed integrally with one another to increase heat dissipation. The first electrode connector 16 comprises a first channel 1602 in which the second electrode connector 14 is fixedly disposed. The positive electrode of the circuit board 7 is soldered to the second electrode connector 14. The first insulator 15 is disposed between the second electrode connector 14 and the first electrode connector 16 so as to prevent short circuit.

The first cover 17 is disposed on the base 28. The first cover 17 comprises a second sidewall 1706 and a third headwall 1705 disposed on one end of the second sidewall 1706. A third cavity 1702 is surrounded by the third headwall 1705 and the second sidewall 1706. The first headwall 14 is disposed opposite to the third headwall 1705. The base 28 comprises a third sidewall 2801 and a fourth headwall 2809 disposed on one end of the third sidewall 2801. The second sidewall 1706 is disposed around the third sidewall 2801, and an air channel 1704 is formed between the second sidewall 1706 and the third sidewall 2801. The air channel 1704 functions as a second air intake part. The third headwall 1705 comprises a second through hole 1701. The bottom part of the first electrode connector 16 is disposed through the second through hole 1701 into the third cavity 1702. The top part of the first electrode 20 is screwed to the bottom part of the first electrode connector 16 so that the first electrode connector 16 is secured to the first cover 17. The first electrode 20 comprises a second channel 2001. The second insulator 21 is disposed in the second channel 2001 to sleeve the second electrode 19. The top part of the second electrode 19 is connected to the bottom part of the second electrode connector 14, and the bottom part of the second electrode 19 is wrapped around the second fixing part 22. The first electrode 20 is fixedly disposed on the first fixing part 23 by the second screw 18.

A second chamber 1703 is formed between the first cover 17 and the first headwall 24. The air channel 1704 communicates with the second chamber 1703 so as to allow external air to enter the second chamber 1703.

The second electrode connector 14 comprises a third channel 1401 in which the temperature monitoring tube 12 is disposed. The sleeve 13 is disposed on the top part of the inside of the third channel 1401 so as to fix the temperature monitoring tube 12 in the third channel 1401. The first chamber 2605 comprises a hole 2602. The temperature monitoring tube 12 is disposed through the sleeve 13, the third channel 1401, and the second electrode 19 successively, and enters the hole 2602. The temperature sensor 11 is disposed in the temperature monitoring tube 12 and electrically connected to the circuit board 7 to monitor the temperature of the heating element 25. When the temperature exceeds a setpoint value, the temperature sensor 11 sends the temperature feedback to the circuit board 7, and the circuit board 7 maintains the heating element at a desired temperature, thus preventing the heating element from overheating. The heating element 25 comprises an input terminal, comprising a positive electrode and a negative electrode. The positive electrode of the heating element 25 is soldered to the second fixing part 22, and the negative electrode is soldered to the first electrode 20.

The tobacco chamber 29 comprises a first cavity 2901 for holding the tobacco materials. The bottom end of the tobacco chamber 29 shrinks and extends axially to form an exhaust pipe 2902. The exhaust pipe 2902 communicates with the tobacco chamber 29. The second headwall 2609 is disposed on the open top of the tobacco chamber 29.

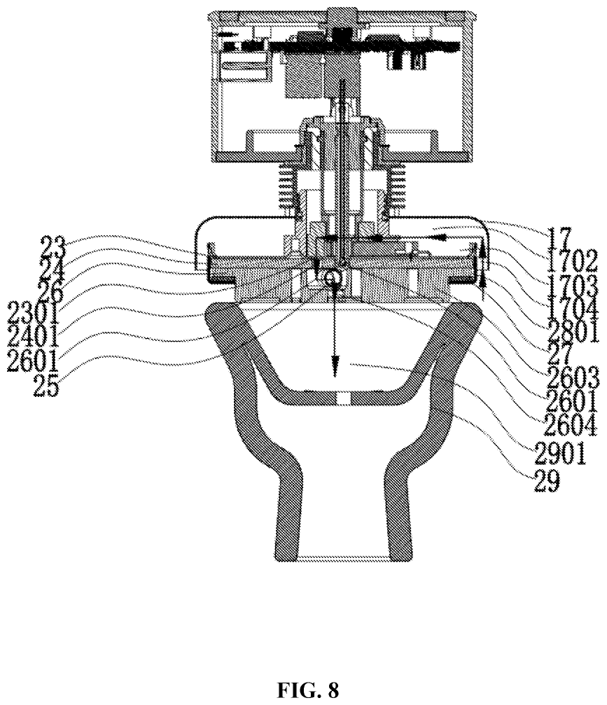

FIG. 8 is a cross-sectional view including arrows showing the direction of airflow in the vaping device of the disclosure. When the heating element 25 is energized, the heat is produced and concentrated in the first chamber. When the user smokes the tobacco material, external air flows through the air channel 1704, the second chamber 1703, the plurality of air inlets, the plurality of fourth through holes 2301, and the separate part 2601 successively, forcing the heat from the first chamber through the plurality of air outlets to the tobacco chamber. Thus, the tobacco material is heated to produce smoke.

It will be obvious to those skilled in the art that changes and modifications may be made, and therefore, the aim in the appended claims is to cover all such changes and modifications.

What is claimed is:

1. A vaping device, comprising a heating assembly; the heating assembly comprising a first chamber and a heating element disposed in the first chamber; the first chamber comprising a first air intake part and an air release part; wherein the tobacco material is disposed outside of the first chamber, and the air release part is disposed toward the tobacco material.

2. The vaping device of claim 1, wherein the heating assembly comprises a first headwall, a second headwall, and a first sidewall; the first headwall and the second headwall are disposed on both ends of the first sidewall, respectively; the first chamber is surrounded by the first headwall, the second headwall, and the first sidewall; the first air intake part is disposed on the first headwall, and the air release part is disposed on the second headwall.

3. The vaping device of claim 2, wherein the first air intake part comprises a plurality of air inlets, and the air release part comprises a plurality of air outlets; the plurality of air inlets communicates with the plurality of air outlets through the first chamber; and projections of the plurality of air inlets onto the second headwall do not overlap with the plurality of air outlets.

4. The vaping device of claim 2, wherein the vaping device further comprises a tobacco chamber comprising an open top; the tobacco chamber comprises a first cavity for holding the tobacco material; the second headwall is disposed on the open top to cover the first cavity; and the air release part is disposed toward the tobacco material.

5. The vaping device of claim 1, wherein the vaping device further comprises a control assembly; a heat dissipation space is formed between the control assembly and the heating assembly.

6. The vaping device of claim 5, wherein the heating assembly further comprises a distal end away from the tobacco material; the control assembly is disposed on the distal end; and the vaping device further comprises a plurality of fins disposed in the heat dissipation space.

7. The vaping device of claim 6, wherein the control assembly further comprises a shell and a circuit board; and the shell comprises a second cavity in which the circuit board is fixedly disposed; the vaping device further comprises a first electrode connector and a second electrode connector; the heating element is electrically connected to the circuit control board through the first electrode connector and the second electrode connector; the heat dissipation space is formed outside the shell; the first electrode connector and the second electrode connector are, at least partially, disposed in the heat dissipation space; and the plurality of fins is disposed on the first electrode connector and/or the second electrode connector.

8. The vaping device of claim 7, wherein:
the heating assembly further comprises a first electrode and a second electrode; the heating element is electrically connected to the first electrode and the second electrode; the first electrode and the second electrode are electrically connected to the first electrode connector and the second electrode connector, respectively;
the shell comprises a through hole; one end of the first electrode connector is disposed through the through hole into the second cavity to electrically connect to the circuit board; another end of the first electrode connector is disposed through the through hole and exposed outside the shell, to electrically connect to the first electrode;
the first electrode connector comprises a first channel in which the second electrode connector is disposed; the vaping device further comprises a first insulator disposed between the second electrode connector and the first electrode connector; one end of the second electrode connector is electrically connected to the circuit board; another end of the second electrode connector is electrically connected to the second electrode;
the first electrode comprises a second channel in which the second electrode is disposed; the vaping device further comprises a second insulator disposed between the second electrode and the first electrode; and
the plurality of fins extends radially outward from an outer wall of the first electrode connector.

9. The vaping device of claim 2, wherein the vaping device further comprises a first cover disposed outside the first headwall; a second chamber is formed between the first cover and the first headwall; and the vaping device further comprises a second air intake part disposed in the second chamber.

10. The vaping device of claim 9, wherein the heating assembly further comprises a base; the first cover is disposed on the base; the first cover comprises a third headwall and a second sidewall; the third headwall is disposed on one end of the second sidewall; a third cavity is surrounded by the third headwall and the second sidewall; the first headwall is disposed opposite to the third headwall;
the base comprises a fourth headwall and a third sidewall; the fourth headwall is disposed on one end of the third sidewall; the second sidewall is disposed around the third sidewall, and an air channel is formed between the second sidewall and the third sidewall.

11. The vaping device of claim 10, wherein the fourth headwall comprises a first through hole, and the distal end of the first sidewall extends radially outward to form a flange; the first sidewall and the second headwall are disposed through the first through hole, and the flange is disposed on the fourth headwall; the third headwall comprises a second through hole; the heating assembly is disposed through the second through hole to be energized by a power supply.

12. The vaping device of claim 2, wherein
the heating element is disposed in the first chamber; when energized, the heating element converts electrical energy into heat energy; a plurality of partitions is disposed on the second headwall to separate the first chamber into a plurality of separate parts; the heating element is disposed in the plurality of separate parts; and
the plurality of separate spaces communicates with one another to form a passage; two ends of the heating element extend in the passage so that the heating element stretches in each separate space.

13. The vaping device of claim 12, wherein
the plurality of partitions comprises a plurality of main partitions with different sizes; each of the plurality of main partitions is in the shape of a ring with an opening; a separate part is formed between every two adjacent main partitions; a smaller main partition is disposed in an adjacent larger main partition, and the opening of the smaller main partition and the opening of the adjacent larger main partition are disposed in two opposite directions; and
each of the plurality of partitions further comprises a joint and an auxiliary partition; the joint is disposed opposite to the opening; and the auxiliary partition extends from the joint through the opening of adjacent larger main partition.

14. The vaping device of claim 2, wherein the first headwall comprises a thermally insulating material; the second headwall is formed integrally with the first sidewall; the second headwall and the first sidewall comprise thermally-conductive and electrically insulating materials; and the heating element comprises a heating wire and/or a heating tube in a spiral shape.

15. The vaping device of claim 8, wherein the heating assembly further comprises a temperature sensor disposed in the first chamber and electrically connected to the circuit board; and the temperature sensor is disposed in or close to a middle position of the first chamber.

16. The vaping device of claim 15, wherein the heating assembly further comprises a temperature monitoring tube; and the second electrode connector comprises a third channel in which the temperature monitoring tube is disposed; the second electrode comprises a third through hole; the temperature monitoring tube is inserted into the first chamber through the third channel and the third through hole.
